(19) United States
(12) Patent Application Publication
(10) Pub. No.: US 2011/0233124 A1
(43) Pub. Date: Sep. 29, 2011

(54) ACIDIC WATER AND ITS USE FOR DRAINAGE OR SEPARATION OF SOLIDS

(76) Inventor: Pentti Virtanen, Valkeakoski (FI)

(21) Appl. No.: 13/124,478

(22) PCT Filed: Oct. 15, 2009
(86) PCT No.: PCT/FI2009/050829

§ 371 Date: Jun. 9, 2011

(30) Foreign Application Priority Data
Oct. 15, 2008 (FI) 20085969

(51) Int. Cl. C02F 1/52; B03D 3/06

(52) U.S. Cl. 210/198.1; 252/60

(57) ABSTRACT

The present invention relates to an aqueous composition, which has a pH value of 6.0-9.0 and which contains salts or esters or both of carbonic acid at a concentration, which is at least 0.01% calculated from the total weight of the aqueous composition, and flocculants, coagulants, or microparticles or a mixture thereof as retention agents, as well as to a method for manufacturing said composition and to the use of said composition for manufacturing paper, for separating water from solid material in filtration, for water treatment, for waste water treatment and for waste sludge treatment.

### CROSS REFERENCE TO RELATED APPLICATIONS

This application is entitled to the benefit of and incorporates by reference essential subject matter disclosed in International Patent Application No. PCT/FI2009/050829 filed on Oct. 15, 2009 and Finnish Patent Application No. 20085969 filed Oct. 15, 2008.

### FIELD OF THE INVENTION

The present invention relates to the separation of an aqueous solution and suspended solids from each other, in other words to dewatering and separation of suspended solids. Particularly, the invention relates to an aqueous composition which is suitable for the use in this separation, a method of manufacturing said composition, and a method for manufacturing paper with the help of said composition.

### BACKGROUND OF THE INVENTION

Thus, the present invention is suitable for papermaking and additionally for treatment of waste water and for drainage in general. Papermaking relates to the manufacture of paper grades containing filler (or coated broke) and paper grades not containing filler, from the low square weight papers up to the highest square weight papers. The aqueous composition according to the invention can be used successfully in water treatment or in the aforementioned waste water treatment or in treatment of waste sludge. Thus, the invention is also suitable for environmentally friendly uses.

Typically, in papermaking a so called thick pulp is first formed, mainly from fibres, water and inorganic fillers or pigments. Water is by amount the biggest raw material of paper pulp. Thereafter, the thick pulp is diluted and the diluted pulp is passaged through screens and pumps that feed the headbox to the headbox, in which the pulp is spread as homogenously as possible on the whole breadth of the wire. The aim is to separate water and pulp components from each other on the wire. Thereafter, the produced paper is pressed and dried.

In papermaking, retention agents are commonly used for improving dewatering and retention of suspended solids (fixing of suspended solids to paper fibres).

### SUMMARY OF THE INVENTION

An object of the present invention is to improve the formation in addition to retention of suspended solids and dewatering.

Thus, the present invention relates to an aqueous composition, a method for production thereof and the use thereof.

More particularly, the composition has a pH-value of 6.0-9.0 and which contains salts or esters or both of carbonic acid at a concentration, which is at least 0.01% calculated from the total weight of the aqueous composition.

The method according to the invention for manufacturing the composition comprises adding hydroxide sludge to an aqueous solution and lowering the pH of the solution to an area of 6.0-9.0 by passing carbon dioxide into the solution in such a way that the combined concentration of the salts or esters or both of carbonic acid formed from the carbon dioxide and the hydroxide sludge is at least 0.01% calculated from the total weight of the aqueous composition, the method according to the invention for manufacturing paper comprises adding a flocculant, coagulant or microparticles or a mixture thereof to the paper stock as retention agent, in an amount of at least 0.01% calculated from the total weight of the aqueous composition, as well as the rest of the aqueous composition, where the combined concentration of the formed carbonic acid salts or esters or both is at least 0.01% calculated from the total weight of the aqueous composition, and the ingredients are allowed to react, after which paper is pressed from the composition and the use of the composition and the manufacturing method thereof for the purification of raw water, chemically purified water, tail water, drainage water purified to different grades, process water or a mixture thereof, purification of waste water, purification of waste sludge or for improving filtration; for manufacturing the aqueous composition at a paper mill; and for manufacturing the aqueous composition at a water treatment plant, a waste water treatment plant, a waste sludge treatment plant or in filtration.

Using the invention it is possible, for example, to improve the dewatering, the retention of suspended solids and the formation in papermaking. The formation describes into how big flocks the retention agents have fixed together the particles of suspended solids. The formation is a measure of the even distribution of the solids, i.e. an important characteristic describing the paper quality. Acceleration of the dewatering and improving the retention of suspended solids improve the effectiveness of the paper machine (drainage) and the quality of the final product. Faster dewatering on the wire part enables, among others, increasing the speed of the paper machine, dilution of the headbox and, in this way, a better formation and savings in the drying energy of the drying part. Thus, the improvement of the formation is a measure indicating, above all, the improvement of the quality.

### BRIEF DESCRIPTION OF THE DRAWINGS

The examples described below shown, among others, the advantages reached using the present invention.

FIG. 1 shows the dewatering curves of the experimental points used in Example 1.

FIG. 2 shows the retention of suspended solids of the experimental points used in Example 1.

FIG. 3 shows the filler retention of the experimental points used in Example 1.

FIG. 4 shows the drainage speed of the different experimental points used in Example 2.

FIG. 5 shows the drainage times of the experimental points of the first series of experiments of Example 3.

FIG. 6 shows the drainage times of the experimental points of the second series of experiments of Example 3.

FIGS. 7A and 7B show the drainage times of the experimental points of Example 5.

FIGS. 8A and 8B show the filler retention of the experimental points of Example 5.

FIG. 9 shows the drainage times of the experimental points of Example 6.

### DETAILED DESCRIPTION OF THE PREFERRED EMBODIMENTS

The present invention relates to an aqueous composition, which has a pH value of 6.0-9.0, e.g. 6.0-8.0, and which contains salts or esters or both of carbonic acid at a concentration of at least 0.01% based on the total weight of the aqueous composition. The composition also contains retention agents, which preferably are flocculants, coagulants, or microparticles, or a mixture thereof, and which preferably are present in the composition as at least 0.01%, e.g. approximately 0.01-5%, preferably approximately 0.01-3% based on the total weight of the aqueous composition.

Said salts of carbonic acid are preferably inorganic or organic carbonate or bicarbonate salts at normal pressure and the esters are the corresponding esters. More preferably, the salts are carbonate or bicarbonate salts or their mixtures formed from the corresponding hydroxides, most suitably calcium, magnesium, manganese, iron, copper, zinc, hydrogen, sodium, potassium, lithium, barium, strontium or nickel salts, especially preferably calcium salts.

The invention also relates to a method for manufacturing said aqueous composition, wherein hydroxide sludge is added into the aqueous solution and the pH of the solution is lowered to the range of 6.0-9.0 by conducting carbon dioxide into the solution in such a way that the total concentration of carbonic acid salts or esters or both formed from the carbon dioxide and the hydroxide sludge is at least 0.01% based on the total weight of the aqueous composition. The composition is preferably manufactured from a calcium salt of the carbonate by adding calcium hydroxide sludge into the aqueous solution and conducting carbon dioxide into the solution.

According to a preferred embodiment the aqueous solution is raw water, chemically purified water, tail water, drainage water purified to different grades, process water, or a mixture thereof, or thick or dilute paper pulp, preferably drainage water or process water, from which the suspended solids have been separated. When paper pulp is in question, the solid material is preferably still present, mixed into the water.

According to a particularly preferred embodiment, the aqueous composition is manufactured at a paper mill, a water treatment plant, a waste water treatment plant, a waste sludge treatment plant or in filtration.

The aqueous composition according to the invention can be used, among others, for the purification of raw water, chemically purified water, tail water, drainage water purified to different grades, process water, or a mixture thereof, for the purification of waste water, for the purification of waste sludge or for improving filtration. It can also be used for dewatering, for improving retention of suspended solids and formation in paper manufacturing.

According to a particularly preferred embodiment, the composition is used for improving the filtration in filtering organic or inorganic substances, preferably mineral fillers or pigments or polysaccharides or mixtures thereof.

According to a preferred embodiment of the invention, the aqueous composition is used in a method for manufacturing paper, wherein a flocculant, a coagulant, or microparticles, or a mixture thereof, and said aqueous composition are added to the paper stock, wherein the combined concentration of the formed salts or esters, or both, of carbonic acid is at least 0.01%, based on the total weight of the aqueous composition, and the ingredients are reacted with each other. The flocculant is preferably a cationic polyacrylamide, a polyethylene imine or starch, microparticles containing silicon are used as microparticles, which more preferably are bentonite or colloid matter containing silicon dioxide, and the coagulant is a water soluble compound containing aluminium.

Coagulant is usually intended to mean the influencing of the charge of the suspended solids by a polymeric or inorganic additive. The potentially formed flocks are weaker than those formed by flocculants. According to a preferred embodiment of the invention, the coagulant may, in addition to a water soluble inorganic compound containing aluminium, be a polymeric coagulant. This polymeric coagulant has a shorter hydrocarbon chain than a polymeric flocculant. The most suitable polymeric coagulants used herein are of the diallyl dimethylammoniumchloride or amine type or mixtures thereof.

Said coagulants and flocculants are so called retention agents. Traditionally, inorganic cationic coagulants, such as alum, have been used, among others, for dewatering and retention of suspended solids. In the invention, among others different polymeric retention agents, which can be both natural polymers, such as polysaccharides (e.g. starch), and synthetic polymers, such as polyacrylamides, are used as flocculants and they are remarkably more efficient compared to the coagulants. Preferably, inorganic so called microparticles, such as colloidal silicon dioxide (polysilicic acid, silicon dioxide sol, microgel, etc.) and bentonite, are used together with these polymeric retention agents.

Flocculants and coagulants help to increase the speed of the drainage, i.e. the dewatering, and the fixing of suspended solids to each other, i.e. the retention, in processes wherein the separation of suspended solids from water is important.

Microparticle retention systems are based on particularly the aforementioned simultaneous use of polymer and microparticles, and they are very advantageous for use in the present invention as retention systems. The best known commercial microparticle retention systems are Compozil and Hydrocol. In these microparticle systems, the solids are first fixed together using the cationic polymer into large flocks. Thereafter the flocks are broken down. This may happen for example in a stage of higher shear speed of the paper manufacturing process (such as in the passage through the screens or pumps). Simultaneously, as the flocks are broken down, the polymer is degraded and the free polymer chains are positioned parallel to the surface of solids. When a paper manufacturing process is in question, this is followed by the addition of microparticles into the paper stock in a region of a more tranquil shear speed just prior to the separation of the suspended solids from the water in the drainage, for example on the wire part of the paper machine.

The anionic microparticles are very small in size and they are able to refix the solid matter into smaller flocks at the same time as a better combination of quality and effectiveness is achieved. In other words, the formation is better and the dewatering and the retention are at a quite high level when these microparticle systems are used. The microparticles function as kind of a binder together with natural or synthetic polymers.

In general, microparticle systems are able to remarkably increase the level of solid retention and dewatering, but at the same time the formation may suffer compared to no use of retention agents. In order to achieve a fast dewatering, a high retention of solids and a good level of formation, a retention system of a cationic polymeric retention agent, a microparticle and an anionic micropolymer may be used. This is commercially called a Telioform system.

In a one component polymeric retention system a relatively long chained polymer is added to the dilute pulp after the last step of high shear speed (purification, blending and pumping systems such as screens or pumps feeding the headbox) before the headbox in the paper manufacture. In the microparticle system the polymer is added before the step of high shear speed, respectively, whereby the large flocks break down, the polymer chains degrade and settle mainly parallel to the surface of the solids. The microparticle is dispensed after this site to a region of a more tranquil shear speed just prior to the dewatering. A reversed way of addition may also be used in the present invention, as the microparticle retention system is used. In the Telioform retention system the cationic, polymeric retention agent is dispensed prior to the step of high shear speed, in the feed pipings of the headbox. The microparticle and the anionic micropolymer are dispensed after this site just prior to the drainage of the paper pulp.

The used colloidal anionic microparticles include, among others, colloidal silicon dioxide and polysilicic acid that have been modified and may contain elements, such as aluminium or boron or mixtures thereof, or components, such as borosilicates, polyborosilicates and zeolites. These may be present in the aqueous phase or in the silicon oxide particles or in both. Polysilicic acid may be called polysilicic acid microgel, polymeric silicic acid, polysilicate, colloidal silicon dioxide, structured silicon dioxide or polysilicate microgel. Colloidal silicon dioxides modified with aluminium are called colloidal aluminium modified silicon dioxides, which expression includes polyaluminium silicates and polyaluminium silicate microgels. All these forms are covered by the expression colloidal silicon dioxide (Telioform S20) used in the invention.

Colloidal microparticles may form from expandable clays. These are, for example, hectorite, smectite, montmorillonite, nontronite, saponite, sauconite, hormite, attapulgite and sepiolite. All these forms are covered by the expression bentonite (Hydrocol SH) used in the invention.

As examples of cationic synthetic polymers used in the invention, acrylate and acrylamide based polymers, poly(diallyl)dimethylammoniumchloride, polyethylene imines, polyamines, polyamidoamines, vinylamide based polymers, melamineformaldehyde and ureaformaldehyde resins may be mentioned.

Cationic polysaccharides used in the present invention are starches, guar gum, chitosanes, chitins, glycans, galactanes, glucanes, xanthan gums, pectines, mannanes and dextrines, preferably starches and guar gums. Starch is preferably manufactured from potatoes, corn, wheat, tapioca, rice or oat.

According to a preferred embodiment, the used polymers are cationic starch and acrylamide based polymer, used separately, together or with other polymers.

The used polymers may be linear, branched or cross-linked. They are most suitably water soluble or water dispersible.

The fibers may be from chemical cellulose pulp or mechanical pulp and they are preferably sulphate or sulphite cellulose fiber, soluble cellulose, organosolve, fibers from chemimechanical (CTMP) or thermomechanical (TMP) pulp or pressurised groundwood (PGW), recycled fibre or fibre from deinked pulp.

The suspended solids preferably contain mineral fillers or coating pigments, which more preferably are kaolin, titanium dioxide, gypsum, talk, ground calcium carbonate (GCC), precipitated calcium carbonate (PCC) or satin white.

The other chemicals, such as optical brighteners, plastic pigments, dyes, fixatives, wet strength agents, dry strength agents, and aluminium compounds, are also suitable for use in the context of the present invention. Examples of suitable aluminium compounds are alum, aluminates, aluminium chloride, aluminium nitrate, and polyaluminium chemicals. Suitable polyaluminium chemicals are polyaluminium chloride, polyaluminium sulphate, polyaluminium compounds containing chlorides or sulphates or both, polyaluminium silicate silicates, and mixtures thereof. Thus, the polyaluminium chemicals may also contain other anions than chlorides, for example anions derived from sulphuric acid, phosphoric acid or organic acids, such as citric or oxalic acid. As aluminium compounds are used in a separation of suspended solids from water according to said invention, it is often advantageous to add these into the paper stock before the addition of polymer or microparticles.

Of the fixatives, such as the coagulants herein, the most preferred are polydadmac (polydiallyldimethylammoniumchloride) and polyamide type anionic collectors of disturbing matter. As wet strength agents, for example polyamideaminepichlorohydride resin (PAAE), ureaformaldehyde resin (UF), melamineformaldehyde resin (MF), and glyoxal polyacrylamide are used.

The process according to the present invention may be used for manufacturing paper from all types of pulp, such as mechanical or chemical pulps, recycled fibre, deinked pulp, or mixtures thereof. Said chemicals may be added to the pulp in the order of to the following examples or in some other order. Typically, the treatment with Ca(OH)₂ sludge and carbon dioxide is advantageously performed for the large amounts of drainage water on the paper machine—to raw water, tail water, drainage water purified to different grades (for example to clear drainage water), mixtures thereof, or for another such drainage water, which is separated from the suspended solids. It is also possible to treat the paper pulp (thick or dilute), in which the suspended solids are combined with the water.

Likewise, in waste water treatment, water purification, or in the treatment of waste sludge, it is possible to treat matter, in which the suspended solids are present in the water, unseparated. Thus, the present process is generally applicable for separation of solid matter from water by drainage.

According to the present invention, it has surprisingly been found that accelerated dewatering combined with a higher level of retention of suspended solids and good formation is achieved using tail water (or drainage water) that has been treated with Ca(OH)₂ sludge and carbon dioxide. The formed carbonic acid salts or esters are of an anionic nature and function in a similar way as the aforementioned other microparticles. These salts of carbonic acid and/or states of carbonates at pH 6.0-9.0 (particularly 6.0-8.0) are so small that their number in the same volume unit is large, whereby they enable the rejoining together of the flocks that have broken down at the higher shear speeds. Particularly, this effect is emphasized when the solid matter has been treated with a cationic natural or synthetic polymer.

The flocculants and coagulants used may be linear, i.e. unbranched, partially unbranched, or completely branched, or combinations thereof. The flocculants or coagulants may be partially cross-linked or bridged.

Most cost-effectively, the manufacture of the composition according to the invention may be arranged either at a paper mill or a water purification or waste water treatment plant, wherein the large amounts of water are, from which the solid matter is to be separated.

### EXAMPLES

### Example 1

In this Example, a Moving Belt Former (MBF) device, where it is possible with the aid of vacuum suction and foils (moving belt under a stationary wire) to study dewatering, retention, and formation characteristics of paper pulp, was used. In the experiments, an increasing suction profile was used in the MBF. Uncoated fine paper machine headbox pulp, which contained all other ingredients used in paper manufacture except the retention agents, was used as the paper pulp. In other words, the headbox pulp was collected after the pumps feeding the headbox, before dispensing the retention agent. The headbox pulp contained precipitated calcium carbonate (PCC) as filler. Cationic polyacrylamide (Percol 3030), bentonite (Hydrocol SH), and anionic micropolymer (Telioform M305) were used as retention agents. As the blending profile for the pulp in the MBF the following was used: 500 rpm for 35 seconds, 1500 rpm for 30 seconds, and 500 rpm for 10 seconds, before the beginning of the drainage in the MBF. Thus, the total time for dispensing the retention agents for the drainage of the headbox pulp was 75 seconds.

Cationic polyacrylamide (P3030) was dispensed either at 150 g/t or 300 g/t at a speed of 500 rpm at 32 seconds. Bentonite (SH) was dispensed in an amount of 2 kg/t at 68 seconds at a speed of 500 rpm. Anionic micropolymer (M305) was also dispensed at 68 seconds at a speed of 500 rpm. Bentonite and micropolymer were dispensed separately, but simultaneously.

The use of a cationic polyacrylamide and bentonite corresponds to the so called Hydrocol retention system. The use of a cationic polyacrylamide, bentonite and micropolymer corresponds to the so called Telioform retention system.

The consistency of the headbox pulp at the experimental point A (see Table 1) was 3 g/l. In the following experimental points (B-F) the aforementioned retention agents were dispensed into the headbox pulp, which was diluted to a consistency of 3 g/l with clear drainage from a fine paper machine. At these experimental points, 25 litres of liquid discharge was decanted from the headbox pulp diluted with clear drainage and having a consistency of 3 g/l. Before collecting the liquid discharge, the suspended solids of the headbox pulp was allowed to settle for 24 hours. To this liquid discharge 50 grams of 15% Ca(OH)₂ sludge was added. Thereafter, a sufficient amount of CO₂-gas was bubbled into the liquid discharge to decrease the pH to 6.5. The bubbling of carbon dioxide gas was repeated again after 5 hours and again the pH was decreased to 6.5. The liquid discharge treated in this way, which hereafter is called “acidic water”, was used in the MBF for diluting the headbox pulp to a consistency of 3 g/l. From the liquid discharge only the liquid discharge settled for 5 hours was used. The non-colloidal material remaining at the bottom of the vessel was left unused. The mean particle size measured from this “acidic water” liquid discharge was about 60 nm (Malvern Nano-ZS). From each experimental point (Table 1) ten reiterations were taken.

TABLE 1
Experimental points

| Experimental point | P3030, g/t | SH, kg/t | M305, g/t | Dilution water |
|---|---|---|---|---|
| A | 300 | 0 | 0 | clear drainage |
| B | 300 | 0 | 0 | acidic water |
| C | 300 | 2 | 0 | clear drainage |
| D | 300 | 2 | 0 | acidic water |
| E | 150 | 2 | 150 | clear drainage |
| F | 150 | 2 | 150 | acidic water |

The target value for the square weight in the MBF was 80 g/m². The filler content was determined by ashing the sheets at 525° C. for two hours. The formation was measured by a Beta Formation tester (Ambertec).

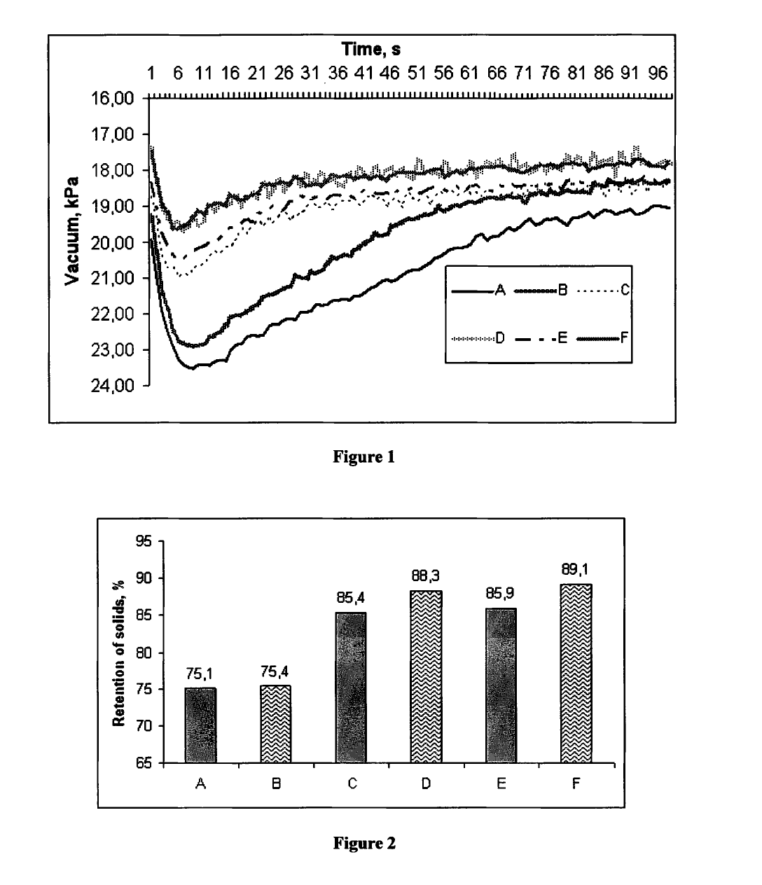

In FIG. 1, the changes of the vacuum level with the change of time are shown in the case of a sheet filtrating on the MBF wire. The higher the curve is, the faster the dewatering of the sheet. When only a cationic polyacrylamide is used as the retention agent, a remarkable improvement in the dewatering of the pulp treated with acidic water (experimental point B) is obtained compared to the use of untreated pulp (experimental point A). Likewise, it is observed that the dewatering is significantly faster when acidic water is used with polyacrylamide and bentonite (experimental point D) compared to the case where no acidic water is used (experimental point C). When polyacrylamide, bentonite, and micropolymer are used together, the situation is the same, i.e. when acidic water is used (experimental point F) a significant improvement is achieved compared to the situation where no acidic water is used (experimental point E).

In FIG. 2 the differences between the different experimental points in the retention of suspended solids are provided. When cationic polymer is used as the retention agent, no differences are achieved between those cases, in which paper pulp is treated with acidic water (experimental point B) or is not treated (experimental point A). Instead, when a combination of polyacrylamide and bentonite is used, an about 3% higher retention of suspended solids is achieved using acidic water (experimental point D) than without acidic water (experimental point C). When a combination of polyacrylamide, bentonite, and micropolymer is used, again an about 3% higher level of retention of suspended solids is achieved using acidic water (experimental point F) than without it (experimental point E).

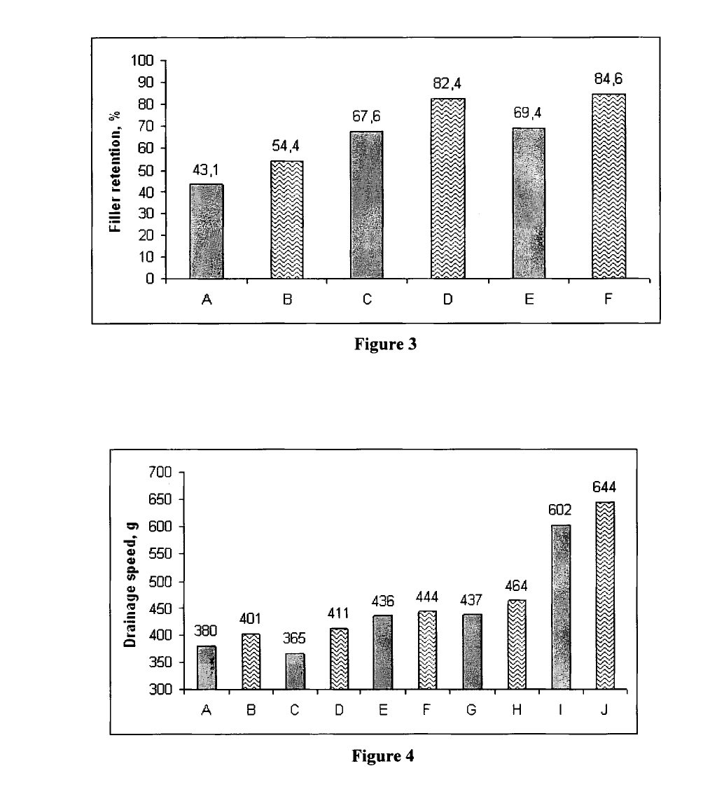

Correspondingly, in FIG. 3 the differences in filler retention between different experimental points are provided. When only a cationic polyacrylamide is used as the retention agent, an about 10% increase in the filler retention level is obtained using acidic water compared to the case where it is not used (experimental points A and B). Correspondingly, when polyacrylamide and bentonite are used as retention agents an about 15% increase in the filler retention level is achieved when acidic water is used (experimental points C and D). An about 15% higher level of filler retention is also achieved when a combination of polyacrylamide, bentonite, and micropolymer is used (experimental points E and F). Experimental points, from which the results are obtained using acidic water, are experimental points B, D, and F.

Differences in the levels of formation between different experimental points are given below in Table 2.

TABLE 2
The formations of the experimental points

| Experimental point | Formation g/m² |
|---|---|
| A | 4.5 |
| B | 4.3 |
| C | 6.6 |
| D | 6.5 |
| E | 5.4 |
| F | 5.3 |

Acidic water gives a very similar formation in experiments carried out using only cationic polyacrylamide (experimental point B) compared to experiments where no acidic water was used (experimental point A). The formation is also on the same level when both polyacrylamide and bentonite are used (experimental points C and D) whether acidic water was used or not. The situation is the same also when a combination of these three retention agents (polyacrylamide, bentonite and micropolymer) was used (experimental points E and F). Again, the experimental points, from which the results are obtained using acidic water, are experimental points B, D, and F.

### Example 2

Dewatering experiments with different combinations of retention agents were carried out using a DFR device (BTG Mütek, DFR 04). The used pulp is headbox pulp obtained after the pumps feeding the headbox of an uncoated fine paper machine, before dispensing the retention agents. The consistency of the pulp was 0.5% and the pulp contained precipitated calcium carbonate (PCC) and other raw materials used on a paper machine. The blending profile in the DFR device was 10 seconds at 400 rpm, 30 seconds at 1000 rpm and 10 seconds at 400 rpm before drainage of the stock. After a 60 second drainage time the weight of the drainage was weighed. The final weight of the drainage in grams represents the drainage speed. Anionic polyacrylamide (Percol 156, later P156), cationic polyacrylamide (Percol 3030, later P3030), bentonite (Hydrocol SH, later SH), and combinations thereof were used as retention agent. P156 or P3030 were administered after 5 seconds at 400 rpm. SH bentonite was administered 45 seconds after starting the experiment at 400 rpm. Thus, the total time for administering the retention agents to the headbox pulp was 50 seconds, before the beginning of drainage. The “acidic water” was manufactured as in Example 1 into the liquid discharge of the headbox pulp. The effect of the so called acidic water on the dewatering characteristics of the paper pulp was elucidated in this experiment. The more drainage, the faster the dewatering of the pulp. Five parallel measurements were performed for each experimental point (see Table 3).

TABLE 3
Used experimental points.

| Experimental point | |
|---|---|
| A | Blanc |
| B | Blanc acidic |
| C | 300 g/t P156 |
| D | 300 g/t P156 acidic |
| E | 2 kg/t SH |
| F | 2 kg/t SH acidic |
| G | 300 g/t P156 + 2 kg/t SH |
| H | 300 g/t P156 + 2 kg/t SH acidic |
| I | 300 g/t P3030 + 2 kg/t SH |
| J | 300 g/t P3030 + 2 kg/t SH acidic |

In FIG. 4 the differences between these experimental points in drainage speed are shown. The headbox pulp treated with acidic water has better dewatering characteristics even as such, which can be seen by comparing the experimental points A (no acidic water) and B (acidic water). Anionic polyacrylamide (P156) has an effect impairing dewatering (experimental point C). Instead, treatment with acidic water and an anionic polyacrylamide seems to have an effect somewhat improving the dewatering (experimental point D). The addition of bentonite (SH) improves the dewatering properties of both untreated pulp (experimental point E) and pulp treated with acidic water (experimental point F). However, the pulp treated with acidic water has better dewatering ability than the untreated pulp. The addition of anionic polyacrylamide (P156) and bentonite (experimental point G) does not improve the level of dewatering achieved by mere bentonite (experimental point E). Instead, the anionic polyacrylamide (P156) improves dewatering when used with bentonite (experimental point H) compared to the level of dewatering achieved using mere bentonite and acidic water (experimental point F). Cationic polyacrylamide (P3030) together with bentonite (SH) clearly improves dewatering both in experiments performed without acidic water (experimental point I) and in the experiment performed with acidic water (experimental point J). However, the best drainage speed is clearly obtained using the acidic water treatment (experimental point J).

### Example 3

The dewatering characteristics of an uncoated fine paper pulp were tested using a Freeness device (Canadian Standard Freeness tester). Cationic polyacrylamide (Percon 182, P182), bentonite (Hydrocol SH, SH) and colloidal silicon dioxide (Telioform S20, S20) were used as retention agents. The retention chemicals were added to a 0.55% headbox stock in a DDJ (Britt jar). The blending profile used in the DDJ was 500 rpm 10 seconds, 1500 rpm 30 seconds and 500 rpm 10 seconds. Thereafter, 700 ml of filtrate was drained from a 1000 ml sample in the Freeness device and the time spent for this was recorded.

In the first test run (see Table 4), the cationic polyacrylamide (P182) was added at 5 seconds at a speed of 500 rpm. Bentonite (SH) or colloidal silicon dioxide (S20) was added after 45 seconds from the start of the experiment at a speed of 500 rpm. Thereafter one litre of headbox stock was drained using the Freeness device. In the second test series either bentonite (SH) or colloidal silicon dioxide (S20) was added at 5 seconds at a 500 rpm speed and cationic polyacrylamide (P182) was added at 45 seconds at 500 rpm speed. Thereafter, one litre of headbox pulp was drained with the Freeness device. Thus, the order of additions of retention chemicals in said second test series was inverted compared to the first test series. The used acidic water had been manufactured into the liquid discharge of the headbox pulp according to Example 1. Thus, the aim was to investigate the effect of the order of additions of the retention agents on the dewatering characteristics.

TABLE 4
Experimental points of the first test series

| Experimental point | P182, g/t | SH, kg/t | S20, g/t | dilution water |
|---|---|---|---|---|
| A | 0 | 0 | 0 | no acidic water |
| B | 300 | 0 | 0 | no acidic water |
| C | 300 | 2 | 0 | no acidic water |
| D | 300 | 0 | 0 | acidic water |
| E | 300 | 2 | 0 | acidic water |
| F | 300 | 0 | 500 | no acidic water |
| G | 300 | 0 | 500 | acidic water |
| H | 0 | 0 | 0 | acidic water |

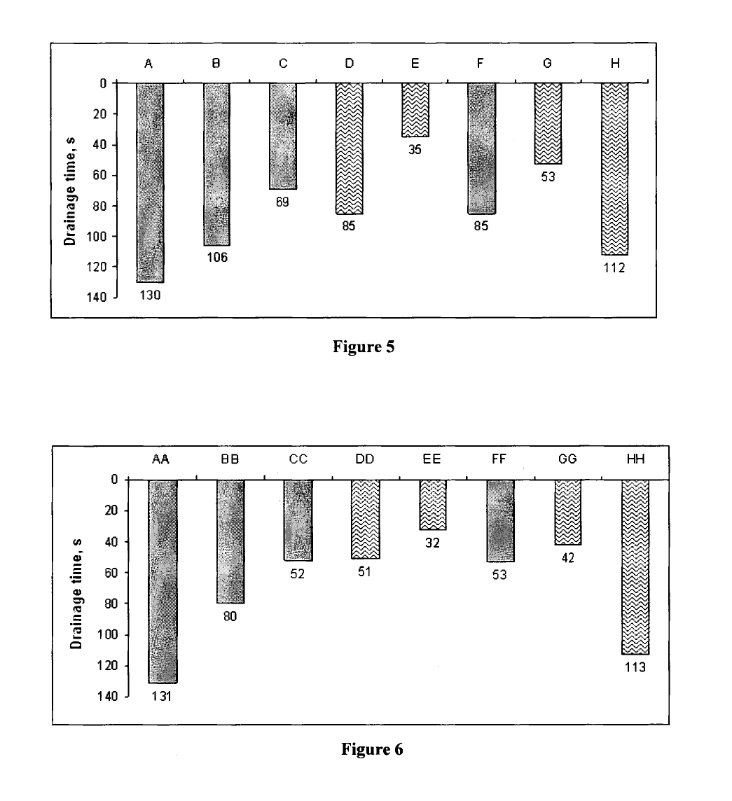

By comparing experimental points A (no acidic water) and H (acidic water) it can be seen that the acidic water accelerates the drainability even without retention chemicals, as is illustrated by FIG. 5. When cationic polyacrylamide (P182) is used, it can be observed that the stock treated with acidic water (experimental point D) is drained considerably faster than if the treatment is not carried out (experimental point B). With combinations of cationic polyacrylamide (P182) and bentonite (SH) a significant improvement of dewatering is achieved. However, yet again the dewatering is considerably faster when acidic water is used (experimental point E) than in the case where the draining is performed with the original headbox pulp (experimental point C). In the case of cationic polyacrylamide (P182) and colloidal silicon dioxide (S20), the situation is the same as above. With the help of acidic water (experimental point F) a clear acceleration of dewatering is achieved (compare to experimental point G).

TABLE 5
The experimental points of the second test series.

| Experimental point | SH, kg/t | S20, g/t | P182, g/t | dilution water |
|---|---|---|---|---|
| AA | 0 | 0 | 0 | no acidic water |
| BB | 0 | 0 | 300 | no acidic water |
| CC | 2 | 0 | 300 | no acidic water |
| DD | 0 | 0 | 300 | acidic water |
| EE | 2 | 0 | 300 | acidic water |
| FF | 0 | 500 | 300 | no acidic water |
| GG | 0 | 500 | 300 | acidic water |
| HH | 0 | 0 | 0 | acidic water |

The drainage results of the second test series are shown in FIG. 6. In this test series the addition of cationic polyacrylamide (P182) is not performed until just prior to the beginning of the filtration test in the Freeness device. The acidic water accelerates the drainability (experimental point HH) even without retention chemicals compared to the situation where untreated headbox stock is drained (experimental point AA). Similarly as in the first test series, a faster dewatering is achieved when acidic water is used with the cationic polyacrylamide (experimental point DD) compared to the situation where it is not used (experimental point BB). Acidic water together with bentonite (SH) and cationic polyacrylamide (P182) helps to achieve (experimental point EE) yet again a considerably faster dewatering compared to the case where these retention agents are added to pulp not treated with acidic water (experimental point CC). The situation is the same as above in the case of colloidal silicon dioxide (S20) and cationic polyacrylamide (P182), i.e. the acidic water (experimental point GG) accelerates the dewatering compared to the case where it is not present (experimental point FF).

### Example 4

### Manufacture of “Acidic Water”

50 g of 40% Ca(OH)₂ sludge was added into the tail water of an uncoated fine paper machine. Thereafter, a sufficient amount of CO₂ gas was bubbled into the tail water to decrease the pH to 6.5. The tail water treated in this way, which below is called “acidic water”, was used in the following Examples 2 and 3.

### Example 5

### The Effect of “Acidic Water” on the Dewatering and Retention Characteristics with Coagulants

Dewatering experiments with different combinations of coagulants (i.e. fixatives) and retention agents were run on a DFR device (BTG Mütek, DFR 4). The “acidic water” vas manufactured according to Example 1 in the tail water of a fine paper machine. The used pulp was stock from the mixing tank of an uncoated fine paper machine. The consistency of the pulp was 2.2% and the pulp contained precipitated calcium carbonate, pulp dyes and other raw materials used in a paper machine, such as polyaluminiumchloride (PAC). The ash content of the pulp was 22%. First cationic corn starch (Raisamyl 70021, later Raisamyl) and thereafter coagulant were added to this pulp at 60 second intervals at 200 rpm rotation speed. The coagulants—Alcofix 159, Alcofix 169, and Raifix 25035—are designated below A159, A169, and Raifix. Alcofix 169 is a poly-ADMAC type coagulant, Alcofix 159 is a polyamine type coagulant and Raifix 25025 is a starch based coagulant.

This pulp was diluted with the so called “acidic water” or with normal tail water to 0.7% consistency before dewatering and retention experiments.

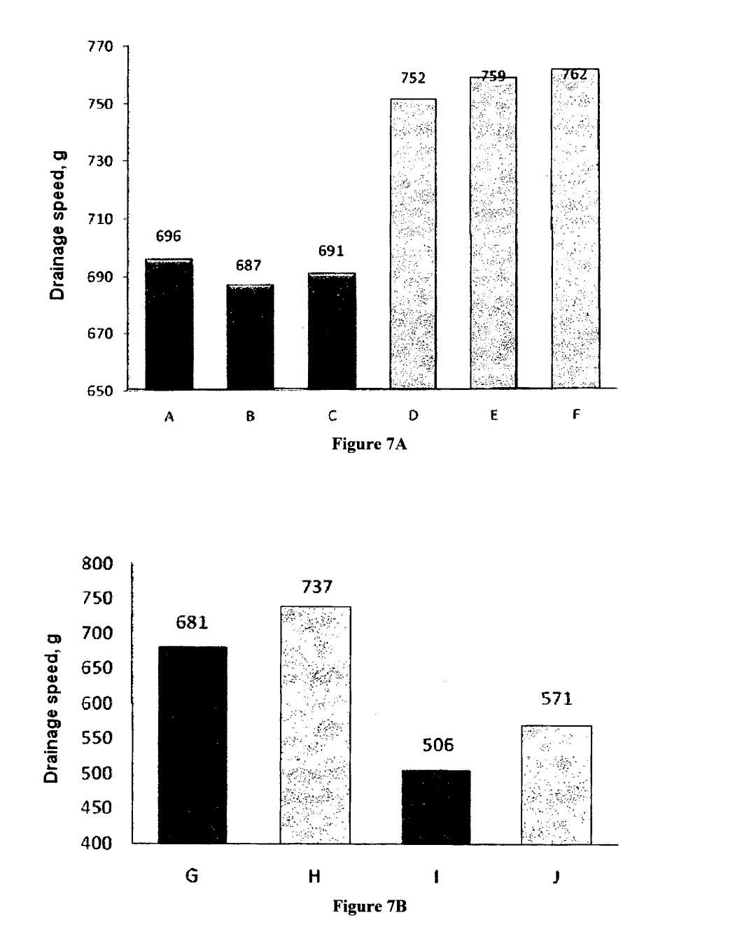

The blending profile in the DFR device was 10 seconds at 400 rpm, 30 seconds at 1000 rpm and 15 seconds at 400 rpm, before the drainage of the stock. After a 55 second drainage time the weight of the drainage was weighed. The final weight of the drainage in grams represents the drainage speed. Cationic polyacrylamide (Percol 3030, later P3030), bentonite (Hydrocol SH, later SH), anionic micropolymer (Telioform M305, later M305), and the combinations thereof were used as retention agents (Table 6 and FIGS. 7A, 7B as well as 8A and 8B).

The ways of administering the different retention agents vary. P3030 is administered after 5 seconds from starting the test at 400 rpm. SH bentonite is administered after 45 seconds from starting the test at 400 rpm. M305 is administered after 50 seconds from starting the test at 400 rpm.

TABLE 6
Experimental points used.

| Exper- | | | | | | | | |
|---|---|---|---|---|---|---|---|---|
| imental | | Rais- | | | | | | |
| point | Water | amyl | A159 | A169 | Raifix | P3030 | SH | M305 |
| A | Not acidic | 5 | 0.5 | 0 | 0 | 0.2 | 2 | 0.1 |
| B | Not acidic | 5 | 0 | 0.5 | 0 | 0.2 | 2 | 0.1 |
| C | Not acidic | 5 | 0 | 0 | 0.5 | 0.2 | 2 | 0.1 |
| D | Acidic | 5 | 0.5 | 0 | 0 | 0.2 | 2 | 0.1 |
| E | Acidic | 5 | 0 | 0.5 | 0 | 0.2 | 2 | 0.1 |
| F | Acidic | 5 | 0 | 0 | 0.5 | 0.2 | 2 | 0.1 |
| G | Not acidic | 5 | 0 | 0.5 | 0 | 0.3 | 2 | 0 |
| H | Acidic | 5 | 0 | 0.5 | 0 | 0.3 | 2 | 0 |
| I | Not acidic | 5 | 0 | 0.5 | 0 | 0.3 | 0 | 0 |
| J | Acidic | 5 | 0 | 0.5 | 0 | 0.3 | 0 | 0 |

(Doses of chemicals are given in units kg/t calculated as the active agent.

From each experimental point five parallel measurements were carried out. The filler content is determined by ashing the sheets at 525° C. for two hours.

From FIG. 7A it can be seen that experimental points D, E, and F, where acidic water has been used, the drainage speed is clearly greater than in experimental points A, B, and C, where no acidic water according to the invention has been used.

From FIG. 7B it can be seen how the acidic water according to the invention improves the removal of water in the microparticle retention system (experimental point G compared to experimental point H). Correspondingly, the dewatering with the help of acidic water with only cationic polyacrylamide (experimental point J) is faster than without this (experimental point I).

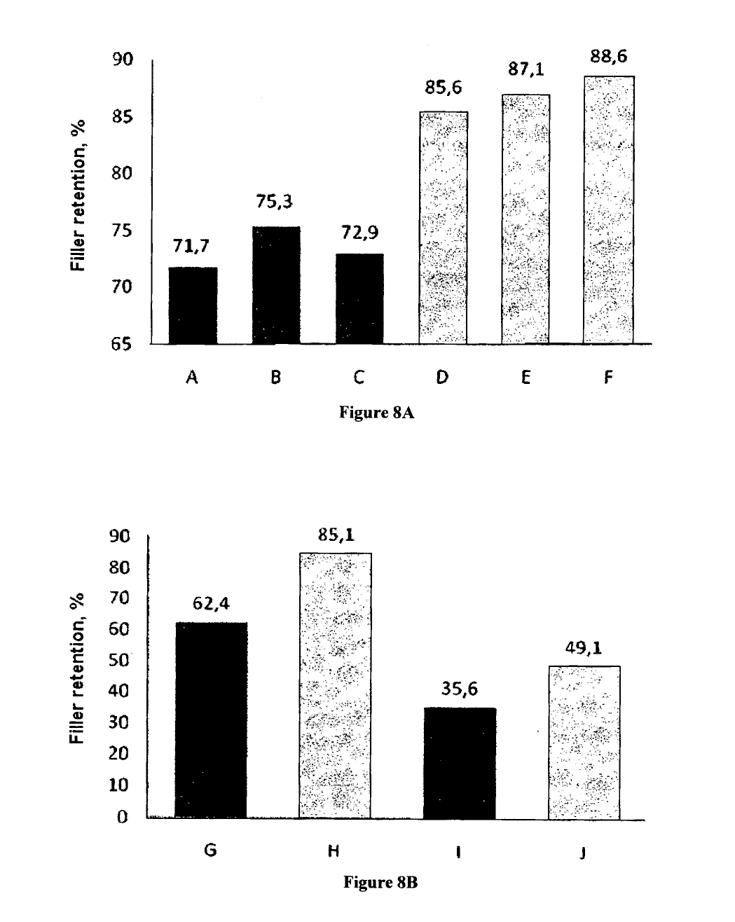

In turn, from FIG. 8A it appears how preferred the use of acidic water (experimental points D, E, and F) are for the filler retention. Correspondingly, the acidic water improves filler retention in a microparticle retention system (experimental point H) as well as with only a cationic polyacrylamide (experimental point J).

All in all, this example shows that the use of acidic water is preferred with both coagulants and flocculants.

### Example 6

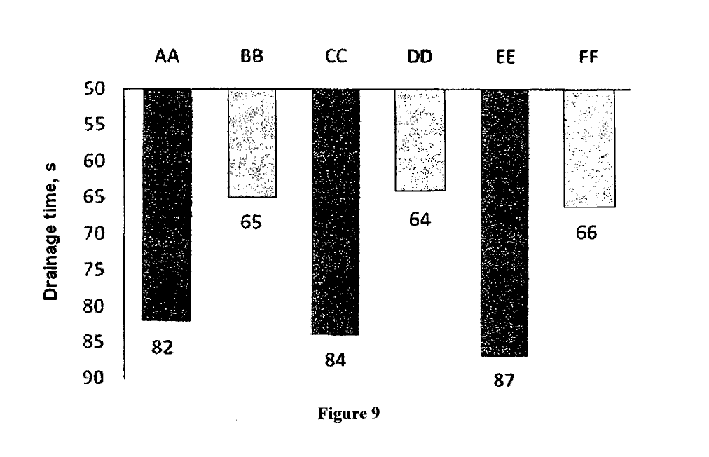

Typically, a test method based on suction by vacuum is more reliable than one that is based on gravity, especially for testing the drainage at board machines. In the experiment of this example the water is sucked away from a pulp of standard volume using a vacuum pump through a filter paper in a suction funnel. The time spent for water removal (drainage time) and the solid matter content of the formed filter cake are measured. Here a Büchner funnel, into which a moistened filter paper (Whatman 541) was tightly set, was used. The funnel was fixed tightly to a suction bottle to which a vacuum pump (Edwards Speedivac 2) was further connected using a tube. For each test, 750 grams of stock was weighed. The stock originated from the mid layer of a folding board machine. The stock consisted of groundwood pulp and a small amount of coated broke. The stock was collected after the mixing tank of the folding board machine. The filtration cakes were dried at 105° C. for two hours. The drainage testing based on suction with a suction pump gives additional information, especially at machines with limited drying, concerning how it is possible to manage with a lower need for drying energy by improving dewatering and how the function of the clamping may be made more effective (Table 7 and FIG. 9).

TABLE 7
Experimental points used

| Experimental point | Water | A159 | A169 | Raifix | SH |
|---|---|---|---|---|---|
| AA | Not acidic | 0.5 | 0 | 0 | 2 |
| BB | Acidic | 0.5 | 0 | 0 | 2 |
| CC | Not acidic | 0 | 0.5 | 0 | 2 |
| DD | Acidic | 0 | 0.5 | 0 | 2 |
| EE | Not acidic | 0 | 0 | 0.5 | 2 |
| FF | Acidic | 0 | 0 | 0.5 | 2 |

FIG. 9 clearly shows that the so called acidic water considerably accelerates the dewatering.

All in all, this example shows how preferred the effect of the acidic water is when coagulants are used together with microparticle (bentonite).

While the present invention has been illustrated and described with respect to a particular embodiment thereof, it should be appreciated by those of ordinary skill in the art that various modifications to this invention may be made without departing from the spirit and scope of the present.

What is claimed is:

1. An aqueous composition, which has a pH-value of 6.0-9.0 and which contains salts or esters or both of carbonic acid at a concentration, which is at least 0.01% calculated from the total weight of the aqueous composition, wherein it further comprises flocculants, coagulants, or microparticles, or a mixture thereof as retention agents.

2. The composition according to claim 1, wherein the salts of carbonic acid are carbonate or bicarbonate salts at normal pressure, preferably having a mean particle size of <0.3 μm.

3. The composition according to claim 1, wherein the carbonate or bicarbonate salt or mixture of these formed from the corresponding hydroxide is an inorganic or organic salt or a mixture of these, preferably a calcium, magnesium, manganese, iron, copper, zinc, hydrogen, sodium, potassium, lithium, barium, strontium, or nickel salt, most suitably a calcium salt.

4. The composition according to claim 1, wherein the flocculants, coagulants or microparticles or the mixtures thereof are present in the composition in at least 0.01%, preferably about 0.01-5%, calculated from the total weight of the aqueous composition.

5. A method for manufacturing an aqueous composition, comprising adding hydroxide sludge to an aqueous solution and lowering the pH of the solution to an area of 6.0-9.0 by passing carbon dioxide into the solution in such a way that the combined concentration of the salts or esters or both of carbonic acid formed from the carbon dioxide and the hydroxide sludge is at least 0.01% calculated from the total weight of the aqueous composition.

6. The method according to claim 5, wherein also flocculants, coagulants, or microparticles, or a mixture thereof are also added to the aqueous composition as retention agent, preferably any of these or a copolymer thereof, as an amount of at least 0.01%, especially about 0.01-3% calculated from the total weight of the aqueous composition.

7. The method according to claim 5, wherein the aqueous composition is manufactured from carbonates by adding a hydroxide sludge into the aqueous solution and passing carbon dioxide into the solution.

8. The method according to claim 5, wherein the aqueous composition is raw water, chemically purified water, drainage water purified to different grades, process water or mechanically purified water or another type of water used at paper mills or a mixture thereof or thick or dilute paper pulp, preferably drainage water or process water, from which the suspended solids have been separated.

9. The method according to claim 8, wherein a paper pulp is first manufactured from the aqueous solution, wherein the suspended solids are mixed into the water.

10. A method for manufacturing paper, comprising adding a flocculant, coagulant or microparticles or a mixture thereof to the paper stock as retention agent, in an amount of at least 0.01% calculated from the total weight of the aqueous composition, as well as the rest of the aqueous composition according to claim 1, where the combined concentration of the formed carbonic acid salts or esters or both is at least 0.01% calculated from the total weight of the aqueous composition, and the ingredients are allowed to react, after which paper is pressed from the composition.

11. The method according to claim 10, wherein the flocculant is a cationic polyacrylamide, polyethylene imine or starch, preferably any of these or a mixture thereof.

12. The method according to claim 10, wherein microparticles containing silicon, which preferably is bentonite or colloidal matter containing silicon dioxide is used as microparticle, more preferably any of these or a mixture thereof.

13. The method according to claim 10, wherein the coagulant is a water soluble compound containing aluminium, amine, or diallyldimethylammoniumchloride (DADMAC), preferably any of these or a mixture thereof.

14. The use of the aqueous composition according to claim 1 for the purification of raw water, chemically purified water, tail water, drainage water purified to different grades, process water or a mixture thereof, purification of waste water, purification of waste sludge or for improving filtration.

15. The use according to claim 14 for improving filtration in the filtration of organic or inorganic agents, preferably of mineral fillers or pigments or polysaccharides or mixtures thereof.

16. The use of the aqueous composition according to claim 1 for improving the dewatering, the retention of suspended solids, and the formation in paper manufacture.

17. The use of the method according to claim 5 for manufacturing the aqueous composition at a paper mill.

18. The use of the method according to claim 5 for manufacturing the aqueous composition at a water treatment plant, a waste water treatment plant, a waste sludge treatment plant or in filtration.
